(19) United States
(12) Patent Application Publication
(10) Pub. No.: US 2025/0149804 A1
(43) Pub. Date: May 8, 2025

(54) Multiband Antenna and Antenna System

(71) Applicant: Alpha Wireless Ltd, Co. Laois (IE)

(72) Inventors: Kok Loon WONG, Portlaoise, Co. Laois (IE); Cao MING, Portlaoise, Co. Laois (IE)

(73) Assignee: Alpha Wireless Ltd, Co. Laois (IE)

(21) Appl. No.: 18/837,999

(22) PCT Filed: Feb. 14, 2023
(86) PCT No.: PCT/EP2023/053613

§ 371 Date: Aug. 13, 2024

(30) Foreign Application Priority Data
Feb. 14, 2022 (GB) 2201879.0

(51) Int. Cl. H01Q 21/26; H01Q 5/42; H01Q 9/44; H01Q 15/00; H01Q 21/06; H01Q 21/30

(52) U.S. Cl. CPC H01Q 21/26; H01Q 5/42; H01Q 9/44; H01Q 15/0013; H01Q 21/062; H01Q 21/30

(57) ABSTRACT

A lower frequency band antenna for a multiband antenna system and an antenna system comprising the lower frequency band antenna and a higher frequency band antenna are disclosed. The multiband antenna system comprises at least one lower frequency band antenna and at least one higher frequency band antenna, the lower frequency band antenna comprising: a substrate mounting a plurality of dipole arms each comprising a plurality of conductive loops, the substrate and dipole arms forming a frequency selective surface predominantly transparent to the higher frequency band and resonating at the lower frequency band. Each of the dipole arms comprises an array of cells, each cell comprising at least one of the plurality of conductive loops configured as an outer conductive cell loop defining an outer periphery of the cell, a size of the outer conductive cell loop determining the higher frequency band that the frequency selective surface is transparent to, and a number of cells in the array determining the lower frequency band that the antenna resonates at.

### CROSS-REFERENCE TO RELATED APPLICATION(S)

This application is a national stage of PCT International Application PCT/EP2023/053613, filed on Feb. 14, 2023, entitled “Multiband antenna and antenna system,” and claims the benefit of priority to UK Patent Application No. GB2201879.0A, filed Feb. 14, 2022, entitled “Multiband antenna and antenna system.”

The contents of each of the above referenced applications are hereby incorporated by reference in their entirety.

### FIELD

The field relates to multiband antennas and antenna systems.

### BACKGROUND

In a multiband system it would be desirable to be able to mount antennas configured to operate in the different frequency bands in proximity to each other perhaps using the same mounting structure. However, a problem may arise where the proximity of one antenna to the other causes distortion in the other antenna's signals.

In particular, an antenna configured to operate in a lower frequency band will be larger than one configured to operate in a higher frequency band and signals in the higher frequency band may induce currents on the metal conducting surfaces of the lower frequency antenna leading to much of the energy from the high frequency antenna being reflected by these metal conducting surfaces and causing distortion in the radiation patterns, variation in azimuth beam width, beam squint, high cross polar radiation and antenna gain problem for the high frequency antenna.

It would be desirable to be able to limit the distortion of the higher frequency band signal by the lower frequency band antenna.

### SUMMARY

A first aspect provides a lower frequency band antenna for a multi-band antenna system comprising at least one lower frequency band antenna and at least one higher frequency band antenna, said lower frequency band antenna comprising: a substrate mounting a plurality of dipole arms each comprising a plurality of conductive loops, said substrate and dipole arms forming a frequency selective surface transparent to said higher frequency band and resonating at said lower frequency band; wherein each of said dipole arms comprises an array of cells, each cell comprising at least one of said plurality of conductive loops configured as an outer conductive cell loop defining an outer periphery of said cell, a size of said outer conductive cell loop determining said higher frequency band that said frequency selective surface is transparent to, and a number and size of cells in said array determining said lower frequency band that said antenna resonates at; wherein at least one of said dipole arms comprises an array of conductive loops with no conductive patches within said outer conductive cell loop.

The inventors recognised that although it may be advantageous to have a multiband antenna where a single antenna system can transmit and receive in multiple bands, problems may arise where current is induced on the metal conducting surfaces of the lower frequency array due to the higher frequency signals which may lead to distortion in the radiation patterns. They have addressed this by providing a Frequency Selective Surface (FSS) on the dipole arms of the antenna the FSS comprising an array of cells each comprising a conductive loop, the conductive loop of the cells being sized to be transparent to the higher frequency band, while the array of conductive loops is configured to resonate at the lower frequency band. In effect the current induced by the higher frequency band is trapped within the loops of the individual cells and is thereby limited. Furthermore, the flow in opposing sides of the loops is in opposite directions providing a reduced cumulative effect from the induced current, the effect of the current in one direction compensating for the effect of the current in the opposite direction.

In this way with careful design and with a simple conductive loop array the lower frequency band antenna can be configured such that it resonates at the lower frequency band but is substantially transparent to the higher frequency band(s) thereby providing an antenna that not only transmits and receives effectively in the desired frequency band but also provides minimal or at least reduced interference for the neighbouring higher frequency band antenna(s).

In some embodiments, all of said dipole arms comprise an array of conductive loops with no conductive patches within said outer conductive cell loops.

In some embodiments, at least one other of said dipole arms comprise cells that each comprise at least one conductive patch within and surrounded by said outer conductive cell loop.

Although conductive loops provide an effective way of reducing the potential distortion caused to the higher band by the presence of the lower band antenna, further control may be provide with conductive patches in a subset of the dipole arms. These may provide induced currents in different frequency bands and allow for an additional pass band for the low frequency antenna.

In some embodiments, said at least one of said dipole arm comprises active elements that consists of said array of said conductive loops.

In some embodiments, said outer conductive cell loops comprises a conductive track forming four sides of said loop, at least one of said sides comprises a conductive track that extends from said conductive loop towards but not as far as a centre of said loop and returns along an adjacent parallel path to form a U-shaped conductive track.

As noted above the conductive loop allows currents to be induced which flow in opposite directions and thereby compensate to some extent for each other. A U-shaped conductive track extending from the conductive loops may have a similar effect and with suitable choice of lengths additional frequency bands that the antenna is substantially transparent to may be achieved.

In some embodiments, said U-shaped conductive track is formed by an indent in said conductive track forming said loop, while in others said U-shaped conductive track is attached to said conductive track forming said loop at two points on said side of said conductive loop.

Although there may only be a single U-shaped conductive track per conductive loop in some embodiments, at least two of said conductive sides of said loop each comprise at least one U-shaped conductive track extending from said side.

Where there are multiple U-shaped conductive tracks in a single loop, in some embodiments, said U-shaped conductive tracks are a same length, while in others at least one of said U-shaped conductive tracks extending from at least one side is a different length to at least one of said U-shaped conductive tracks extending from at least one other side.

Having multiple U-shaped tracks of different lengths may extend the frequency band to which the antenna is substantially transparent and/or may provide further frequency bands at which it is substantially transparent.

In some embodiments, at least one side comprises multiple U-shaped conductive tracks.

In some embodiments, at least two of said multiple U-shaped conductive tracks extending from a same side have different lengths.

In some embodiments, at least one of said dipole arms consists of an array of a first predetermined number of conductive loops and at least one other of said dipole arms consists of an array of a second predetermined number of conductive loops, said first and second predetermined numbers being different numbers.

In some embodiments, the array of cells in each dipole arm is surrounded by an outer conductive dipole loop which resonates at the desired lower frequency band and surrounds the plurality of cells within the dipole arm.

The array of cells in a dipole arm is surrounded by an outer conductive dipole loop which resonates at the desired lower frequency band and surrounds the plurality of cells within the dipole arm, each of the cells having their own cell conductive loops that render the surface substantially transparent to the higher frequency band. The cell conductive loops provide a high pass Frequency Selective Surface (FSS). In some embodiments the cell conductive loop surrounds a conductive patch, the combination of both cell conductive loops and patch/patches provide a band pass frequency selective surface.

In some embodiments, said outer conductive dipole loop surrounding said array of cells on a dipole arm comprises four straight tracks of a substantially same length, the lower frequency band that the dipole arm resonates being related to a size of said outer conductive dipole loop.

Although, the outer conductive dipole loop may have a number of forms, in some embodiments it comprises four straight tracks of a substantially same length, the size of the square which is determined by the length of the sides defining the lower frequency band that the dipole arm resonates at.

In some embodiments, said outer conductive cell loops are substantially square shaped.

In other embodiments, said outer conductive cell loops each have chamfered corners.

In some embodiments said outer conductive cell loops comprise a shape with six or more sides.

Having a conductive loop with six or more sides would have the advantage of corners that were less sharp than in a square shape, but the disadvantage of smaller sides and thus, and for the same wavelength a larger antenna might be required. In some embodiments an outer conductive cell loop of an octagon shape is found to perform well.

In some embodiments, the conductive tracks forming the conductive loops are narrow and this helps reduce the current induced by the higher frequency signal. A potential drawback is that these narrow tracks can cause pinch points at the corners of the squares and having chamfered corners may help or having shapes with six or more sides. In this regard, passive intermodulation is a problem that may occur where the tracks on the radiator are narrow and this can be a particular problem at the corners of loops, providing a loop with chamfered corners avoids the sharp edges and can reduce the effects of passive intermodulation and reduce the current in the loops.

In some embodiments, said chamfered corners comprise concave curved sections joining adjacent straight tracks.

It may be advantageous to form the chamfered corners as curved sections as this reduces any sharp angles and reduces the effect of the narrow tracks, however straight corners would also be possible and indeed in some embodiments, rather than having a square shaped loop, an octagonal loop for example might be provided. Current strength in dipole arms with integrated square loops FSS and patches is about 2 times stronger than dipole arms with integrated chamfered square loops FSS and patches. FIGS. 12 and 13 illustrate the decrease in current that arises with chamfered corners.

In some embodiments, said outer conductive loops around neighbouring cells share conductive tracks, such that a track running along a side of one loop is the same track on an adjoining side of a neighbouring cell.

The conductive tracks forming the conductive loops of neighbouring cells may be shared such that the left-hand track on one cell will be the right-hand track on the other. This sharing of tracks allows the array of conductive cell loops to have a single larger conductive dipole loop around the array of cells in a dipole arm the size of this loop being relevant to the higher side of the lower frequency band that the lower frequency band antenna radiates at, while the diagonal length across two dipole arms that form a dipole of the lower frequency band antenna defines the lower side of the lower frequency band. The plurality of cells that form the frequency selective surface provide the transparency for the higher frequency due to the smaller conductive cell loops of the individual cells that help trap the induced current.

In some embodiments, a subset of said dipole arms comprise cells that each comprise at least one conductive patch within and surrounded by said outer conductive dipole loop, and the other of said dipole arms comprises cells that comprise no conductive patches within said outer conductive dipole loop.

Having one or more conductive patches within the conductive cell loops of the cells of a subset of the dipole arms provides a band pass response, with a relatively flat pass band. The array of conductive patches can be produced by etching paths into a larger metal conductive patch and are designed to generate a lower pass effect, such that the combination of conductive loops and conductive patches act as a band pass filter.

As noted above, it may be advantageous to have one or more conductive patches within a cell enclosed by the outer conductive loop. These conductive patches change the properties of the dipole arm and may provide a band pass filter effect. This may allow transparency of a medium frequency band for some of the dipole arms, while the conductive loops without the patches provide a higher frequency band transparency. Such a lower frequency antenna might be suitable to be used in conjunction with two higher frequency band antenna of different frequency bands.

In some embodiments, a corner of said at least one conductive patch located adjacent to a corner of each of said cells comprises a corresponding chamfered corner.

Where the outer conductive cell loops have chamfered corners then the conductive patches that they enclose may also have chamfered corners.

In some embodiments, at least one of said dipole arms consists of an array of a first predetermined number of conductive loops and at least one other of said dipole arms consists of an array of a second predetermined number of conductive loops, said first and second predetermined numbers being different numbers.

An alternative way of providing different frequency bands at which the lower frequency antenna is substantially transparent may be to provide different numbers and therefore different sized loops on the different dipole arms.

In some embodiments, said conductive tracks have a width of between 0.1 mm and 1.0 mm, preferably between 0.2 mm and 0.5 mm.

Embodiments may have narrow conductive tracks forming the conductive loops, such tracks limit the current induced by the higher frequency signal and improve transparency. They also tend to limit the flow of current to be more directional and improve performance. The thickness of the tracks may be a standard thickness, however in some embodiments, they made thinner than the standard thickness to further limit current flow.

In some embodiments the signal feed is on the other side of the substrate to the conductive loops and patches, and this may be particularly advantageous where the tracks are narrow and thin.

Generally, the conductive tracks in an antenna are thick and wide to provide good bandwidth performance. However, narrower tracks will provide better ultrawide band cloaking as there is less induced current flowing on narrower tracks, and thus, improved performance can be provided. Having chamfered edges or multiple sided loops may also help reduce the current.

A further aspect provides an antenna system comprising at least one lower frequency band antenna according to a first aspect and at least one higher frequency band antenna.

In some embodiments, said antenna system further comprises a signal feed, said signal feed being mounted on another side of said substrate to said conductive loops.

In some embodiments said antenna system comprises at least one further higher frequency band antenna.

There may be two higher frequency band antennas configured to operate at different higher frequency bands, the lower frequency band antenna being substantially transparent to each of the two higher frequency bands.

An aspect provides a lower frequency band antenna for a multiband antenna system, said multiband antenna system comprising at least one lower frequency band antenna and at least one higher frequency band antenna, said lower frequency band antenna comprising: a substrate mounting a plurality of dipole arms each comprising a plurality of conductive loops, said substrate and dipole arms forming a frequency selective surface predominantly transparent to said higher frequency band and resonating at said lower frequency band; wherein each of said dipole arms comprises an array of cells, each cell comprising at least one of said plurality of conductive loops configured as an outer conductive cell loop defining an outer periphery of said cell, a size of said outer conductive cell loop determining said higher frequency band that said frequency selective surface is transparent to, and a size and number of cells in said array determining said lower frequency band that said antenna resonates at; wherein said outer conductive cell loops comprises a conductive track forming four sides of said loop, at least one of said sides comprises at least one U-shaped conductive track extending from said conductive loop towards but not as far as a centre of said loop and returning to said side along a parallel path.

In some embodiments said at least one U-shaped conductive track forms part of said conductive track forming said outer loop, said outer track diverting inwards to form said at least one U-shaped conductive track.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION OF THE DRAWINGS

Embodiments of the present disclosure will now be described further, with reference to the accompanying drawings, in which:

FIG. 1 shows an example multiband antenna;

FIG. 2 schematically shows the high frequency array radiation pattern in the presence of the low frequency array for a multiband antenna according to the example;

FIG. 3 schematically shows the high frequency array radiation pattern in the absence of the low frequency array;

FIGS. 4a and 4b show the measured high frequency array radiation pattern (+45° and −45°) in the presence of the FSS incorporated low band radiators according to an embodiment;

FIG. 5 shows a square conductive loop unit cell with and without chamfered corners;

FIG. 6 shows the transmission response of the conductive loop cell of FIG. 5;

FIG. 7 shows a lower frequency band antenna according to an embodiment;

FIG. 8 shows a lower frequency band antenna that has transparency to two different higher frequency bands according to an embodiment;

FIG. 9A schematically shows the surface current of low frequency dipole arms with integrated FSS; and

FIG. 9B schematically shows the surface current of low frequency dipole arms with integrated FSS and chamfered corners according to an embodiment;

FIG. 10 schematically compares the current flow in the square and chamfered loop FSS;

FIG. 11 schematically shows how the current flow in the loops can weaken current from a higher frequency resonance;

FIG. 12 shows the current flow in an antenna with cells both with and without chamfered corners similar to those shown in FIG. 7; and

FIG. 13 shows the frequency response of the antenna with the chamfered corners of FIG. 12;

FIG. 14 shows an antenna with dipole arms having an FSS formed of 3×3 arrays of chamfered cornered conductive loops;

FIG. 15 shows the frequency response of the antenna of FIG. 14;

FIG. 16 show a chamfered cornered cell with patches that is used as a 3×3 array on a dipole arm;

FIG. 17 shows the transmission response of the cells of FIG. 16 mounted as a 3×3 array on a dipole arm;

FIG. 18 show a chamfered edge cell with no patches that is used as a 3×3 array on a dipole arm;

FIG. 19A-C schematically illustrates conductive loops with U-shaped conductive tracks;

FIG. 19D shows a lower frequency antenna with the conductive loops of FIG. 19A;

FIG. 20A shows a multiband antenna according to one embodiment;

FIG. 20B shows a conventional multiband antenna;

FIG. 20C shows a high-band antenna;

FIG. 20D shows the high frequency array radiation pattern for the antennas of FIGS. 20A-C;

FIG. 21A shows a multiband antenna according to a further embodiment;

FIG. 21B shows a conventional multiband antenna;

FIG. 21C shows a high-band antenna; and

FIG. 21D shows the high frequency array radiation pattern for the antennas of FIGS. 21A-C.

### DESCRIPTION OF THE EMBODIMENTS

Before discussing the embodiments in any more detail, first an overview will be provided.

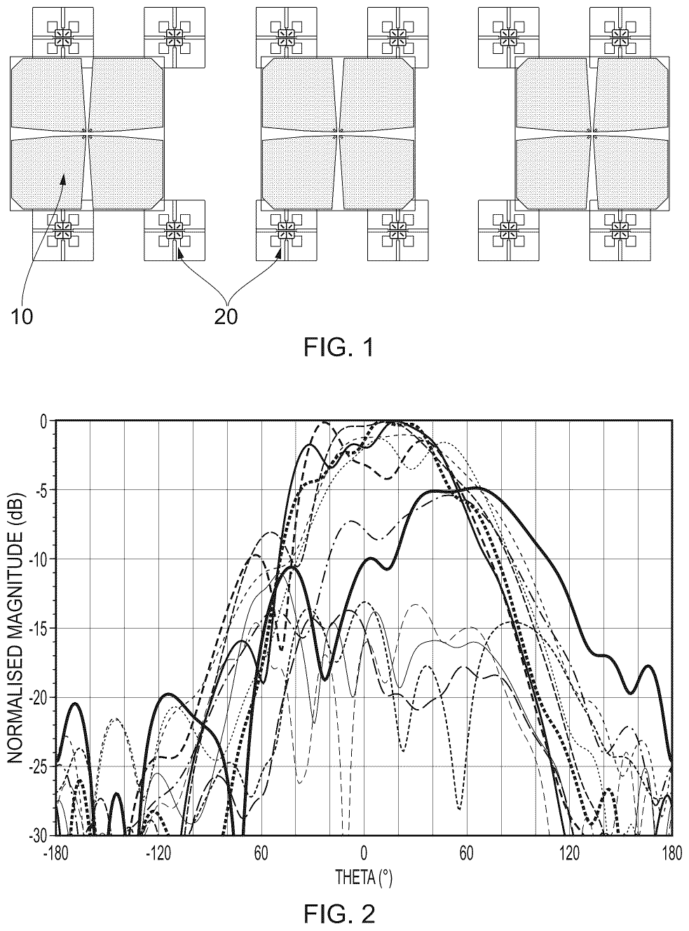

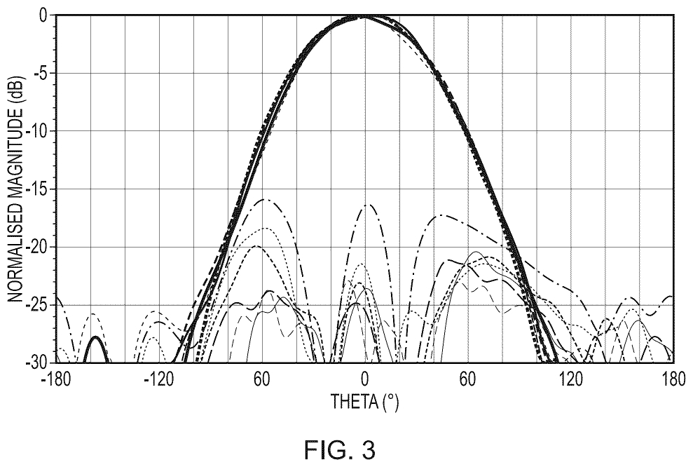

In the example interleaved multiband antenna shown in FIG. 1, where there is a low frequency array comprising lower band radiators 10 and a higher frequency array comprising higher band radiators 20, current is induced on the metal conducting surfaces of the low frequency radiators from signals transmitted by the high frequency radiators. This leads to much of the energy from the higher frequency array being reflected by these metal conducting surfaces and this causes distortion in the radiation patterns, variation in azimuth beam width, beam squint, high cross polar radiation and antenna gain problem for the higher frequency arrays as shown by a comparison of FIGS. 2 and 3. FIG. 2 showing the high frequency array radiation pattern in the presence of the lower frequency array for a multiband antenna according to the example, while FIG. 3 schematically shows the high frequency array radiation pattern in the absence of the lower frequency array. As can be seen the presence of the lower frequency antenna causes considerable distortion to the radiation pattern of the higher frequency antenna.

In WO 1998026471A2, it is proposed to apply frequency selective surfaces in an antenna system to reduce mutual interference effects between two antenna elements. The suggested antenna system comprises a first and a second antenna element. The first antenna element is capable of transmitting in a first frequency range, and the second antenna element is capable of transmitting in a second—i.e. non-overlapping—frequency range. In order to reduce interference effects, the antenna system additionally includes a frequency selective surface which is conductive to radio frequency energy in the first frequency range and reflective to radio frequency energy in the second frequency range. The frequency selective surface comprises repetitive metallization pattern structures that provide a series of interconnected filtration elements that form a single conductive unit and displays quasi band-pass or quasi band-reject filter characteristics to radio frequency signals impinging upon the frequency selective surface.

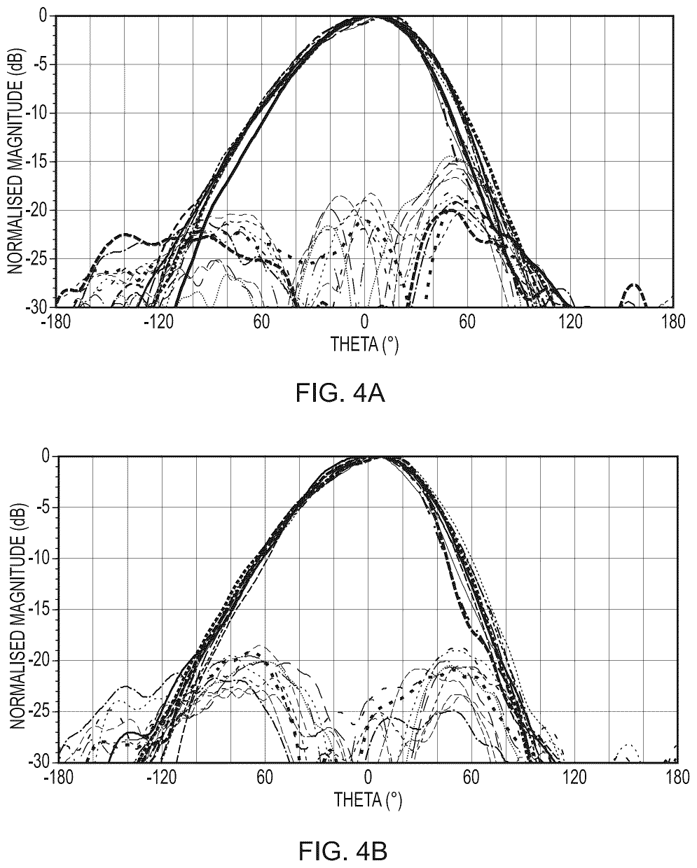

Since the metal conductor of the dipole arms of the lower frequency array are the major factor that contributes to radiation patterns distortion at the higher frequencies and the electrical properties of the metal and dielectric substrate are set, embodiments address the problems of radiation pattern distortion by forming the conductive surface of the lower band antenna as a series of cells having conductive cell loops these conductive loops forming a Frequency Selective Surface (FSS) on the dipole arms. In some embodiments, such a surface may be etched from the metal conducting part of the dipole arms and designed to generate a band pass filter response over the dual polarised high frequency range as shown in FIGS. 4a and 4b. The difference to the example of FIG. 2 where no mitigation is present on the lower frequency antenna can be clearly seen.

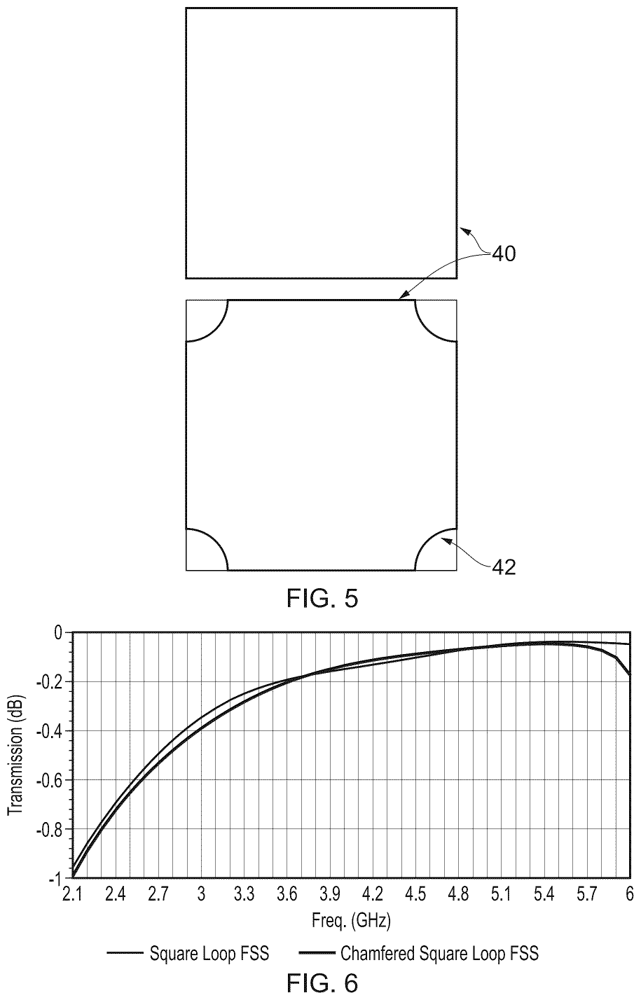

The frequency selective surface may be formed of a plurality of repeating conductive cell loops each forming a unit cell, an array of the unit cells forming one of the dipole arms of the antenna. FIG. 5 shows two examples of such a cell, one comprising an outer cell conductive loop 40 that has a square shape and one comprising an outer cell conductive loop 40 with chamfered edges 42. The size of the conductive cell loop 40 determines the lower frequency of the high frequency band that the low frequency band antenna is transparent to.

FIG. 6 shows the transmission properties of these two loops when mounted as an array of loops on a substrate to form a low frequency band antenna with a frequency selective surface. The transmission of the chamfered corner loop drops at the higher frequencies.

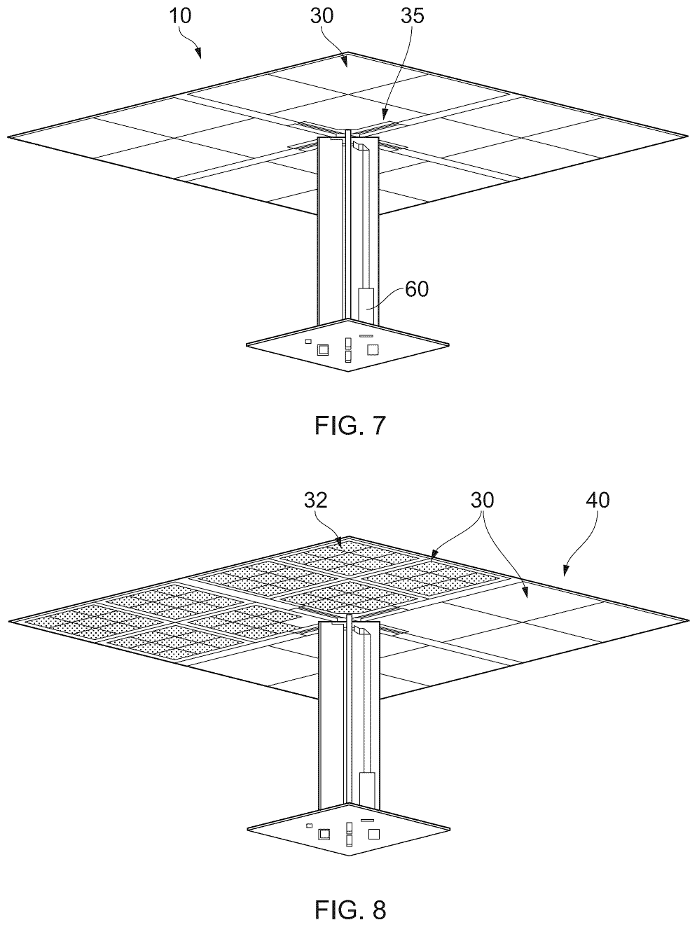

FIG. 7 shows an example of a lower frequency band antenna 10 in which the unit cells 30 comprise conductive cell loops as shown in FIG. 5. They are fed via a signal feed 60 on the stalk and by signal feed arms 35 which again are on the upper surface of the dielectric substrate with the frequency selective surface formed by the conductive loops on the lower side. The transmission properties due to the frequency selective surface of this antenna would be as shown in FIG. 6.

FIG. 8 shows a further embodiment where two of the dipole arms comprise cells 30 with conductive patches 32 surrounded by conductive cell loops and two of the dipole arms comprise the cells 30 with just the conductive cell loops 40. The dipole arm with the conductive loops and patches provide the band pass response while the dipole arms with the conductive cell loops provide the high pass response. Thus, having a combination of dipole arms some of them with the conductive patches and some without provides a lower frequency antenna that has a bandpass and high pass response. Such an antenna could be used in an antenna system with two different higher band frequency antenna. The two different higher band antenna may each be mounted to be aligned with the respective side of the radiating surface of the lower frequency band antenna with the required transmission response.

In this regard, although multiple square cell loops may be used to generate UWB pass filter response over the desired UWB frequency range, it is very difficult to get a good and flat band pass transmission response over the UWB frequency range as deep nulls will be formed in between the resonant frequencies. In order to reduce the formation of nulls, a unit cell with a combination of both conductive loops and patches etched from the metal conducting part of the dipole arms to form FSS arrays are provided to generate a band pass filter response over the ultra wide higher frequency range.

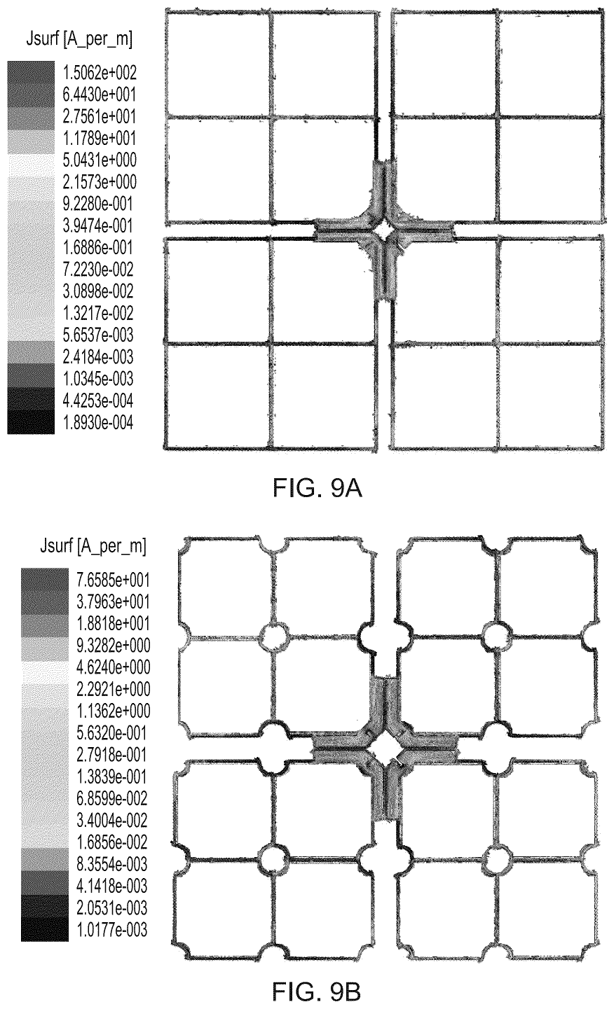

FIG. 9A and FIG. 9B schematically show the surface current running through the conductive loops of a dipole arm of a lower frequency antenna with very thin radiator conductor at 870 MHz according to embodiments. The figures show the reduction in current that is provided by the chamfered edges, the Max current in the square edge embodiment being 150 A/m while that of the chamfered edge embodiment is reduced to 76 A/m. It should be noted that the scale on the two figures is different. Thus, as can be seen the current strength in the dipole arm with integrated square loops is about 2 times larger than the dipole arms with the chamfered squares.

Traditionally, in order to reduce passive intermodulation (PIM) a thicker and wider radiator conductor is generally preferred. However, in order to provide ultra wideband cloaking over the high frequency arrays, the radiator conductor on the low frequency dipole arms is made to be narrower. As a result, PIM which is not desirable, increases, for the low frequency dipole. This has been addressed using chamfered square loop FSS to reduce the current in the loops and to reduce the PIM performance that would otherwise be increased due to the very thin radiator conductor.

Although square grids are shown an octagon loop FSS can also be considered and this would provide a similar effect to chamfered edges. However, the octagon cell size to provide similar arm length to resonate at a specific frequency would need to be larger than a chamfered square loop FSS. The chamfered shaped corners can be angular, rounded, sloped or any shapes. Considering dipole arms either with integrated square loops FSS or chamfered square loops, both configurations have the same radiator conductor thickness. Current strength in dipole arms with integrated aperture grid chamfered square loops FSS has been found to be significantly lower than dipole arms with integrated aperture grid square loops FSS. Current strength in dipole arms with integrated aperture grid square loops FSS is about 2 times stronger than dipole arms with integrated aperture grid chamfered square loops FSS as shown in FIGS. 9A and 9B.

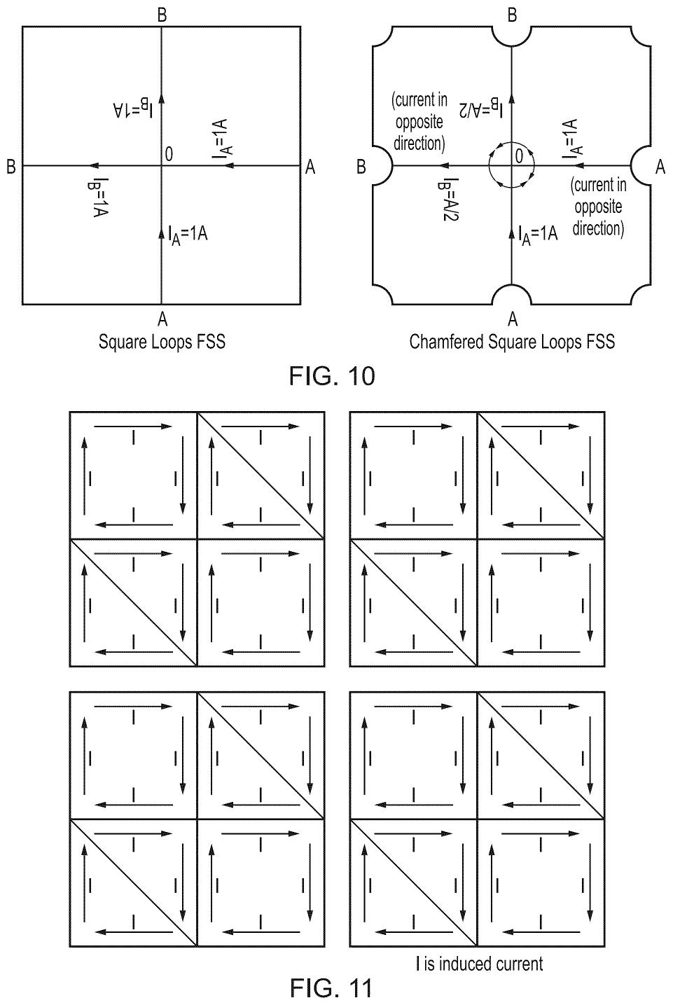

FIG. 10 schematically shows this difference in current flow in a FSS with square loops compared to an FSS with chamfered loops. This figure considers the current flows of a low band dipole arm formed by square loop FSS arrays vs chamfered square loop FSS arrays which have the same track width for both arrays.

Applying Kirchhoff's Current Law to Square Loops FSS, we get the total current at node ‘0’ is IA+IA−IB−IB=1A+1A−1A−1A=0A.

Applying Kirchhoff's Current Law to chamfered square loops FSS, Total current at node ‘0’ is (IA+IA)/2−IB−IB=(1A+1A)/2−A/2−A/2=0A. IA is reduced by half in the chamfered square loops because half of the current path is cancelled due to its opposite direction in the chamfered ring.

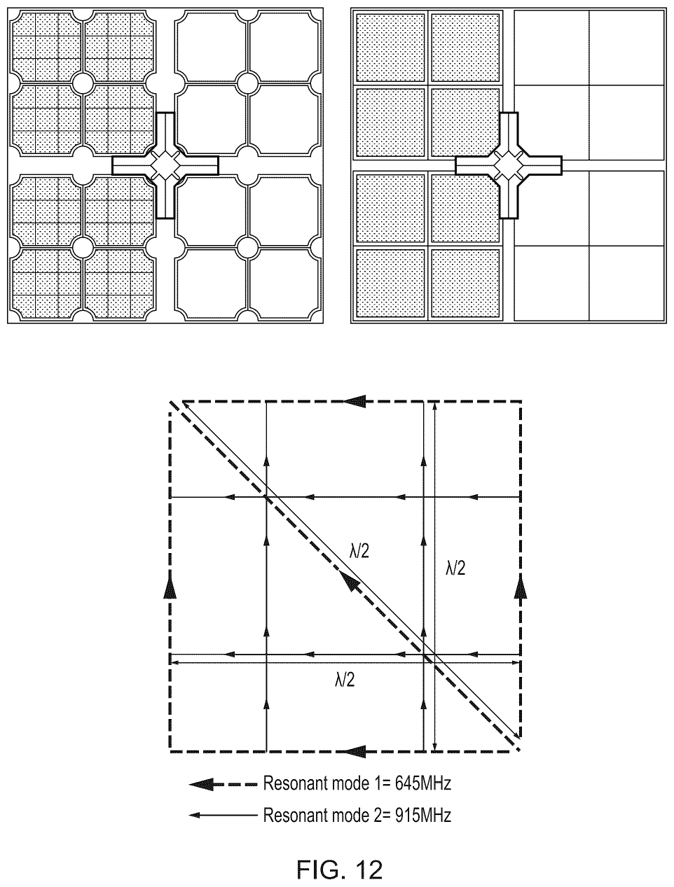

By comparing IB of both Square Loops FSS and Chamfered Square Loops FSS, IB (Square Loops FSS)=2×IB (Chamfered Square Loops FSS). This corresponds with the results shown in FIGS. 12A and 12B where the maximum current density is 151 A/m for square loop FSS arrays and 76 A/m for chamfered square loop FSS arrays, respectively.

FIG. 11 schematically shows how the current induced from a higher frequency signal whose wavelength is small enough to resonate inside each of the loop structures can weaken the overall current due to the higher frequency signal by flowing in opposite directions, such that the cumulative effect is reduced and the antenna is substantially transparent to the higher frequency signal.

FIG. 12 schematically shows the current flowing through the different conductive loops in a dipole antenna of FIG. 8. This would also be applicable to a 3×3 cell dipole arm. As can be seen here is a lower resonant frequency corresponding to the diagonal length of the dipole antenna. The dipole shown is a ±45° cross dipole, so that the diagonal length of the antenna is the dimension that is important for the low frequency resonance and is close to the half wavelength of this resonant frequency. This wavelength shown by the dashed line provides a resonant frequency of 645 MHz.

Another resonant frequency of the low frequency antenna is 915 MHz and this is related to the vertical and horizontal length of the dipole antenna that corresponds to a half wavelength of this dimension. This provides an antenna with a low return loss between these two frequencies.

Each of the unit cells of the antenna of FIG. 12 is relevant to the lower frequency of the high frequency pass band and provides a wide cloaking bandwidth. The total length of each conductive unit cell loop is relevant to a wavelength and in this case gives a resonant frequency close to a centre frequency of the higher frequency band.

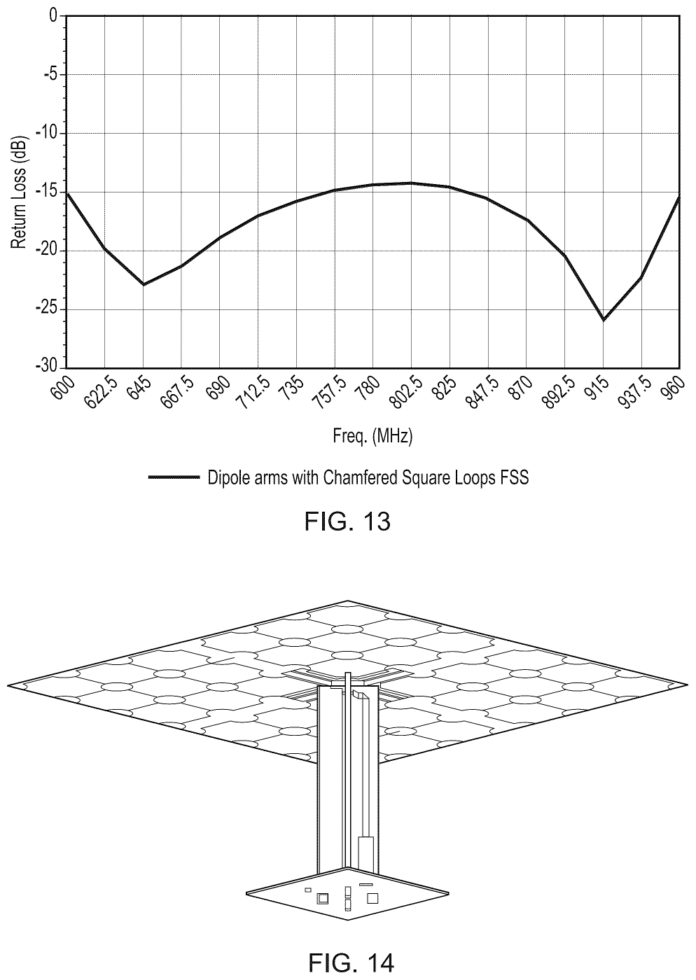

FIG. 13 shows the return loss for a dipole arm with chamfered square loops according to the left hand antenna of FIG. 12. The two resonant frequencies 645 and 915 MHz of the low frequency dipole can be seen.

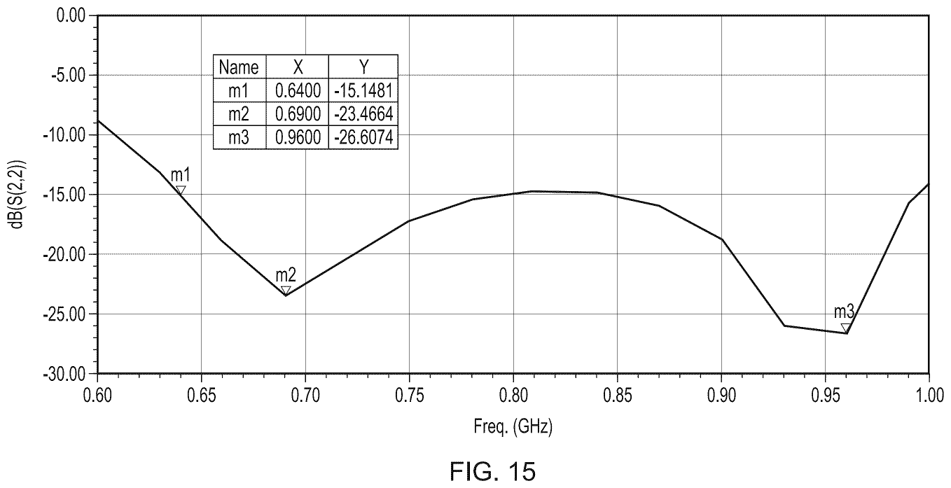

FIG. 14 shows a low frequency antenna with each dipole arm having a 3×3 FSS array of conductive loops with chamfered corners. FIG. 15 shows the return loss for the dipole arm of FIG. 14 and as can be seen when compared with the return loss shown in FIG. 13 that is for a 2×2 array on each dipole arm, the higher of the two resonant frequencies is slightly higher, 690 and 960 MHz.

The 3×3 array within the dipole arms of FIG. 14 gives a UW low frequency and higher frequency band cloaking. In this regard, the higher the number of loops in an arm then the smaller the cells and the higher the frequency band that the antenna is transparent to. In this case the antenna still provides a wide high frequency cloaking band.

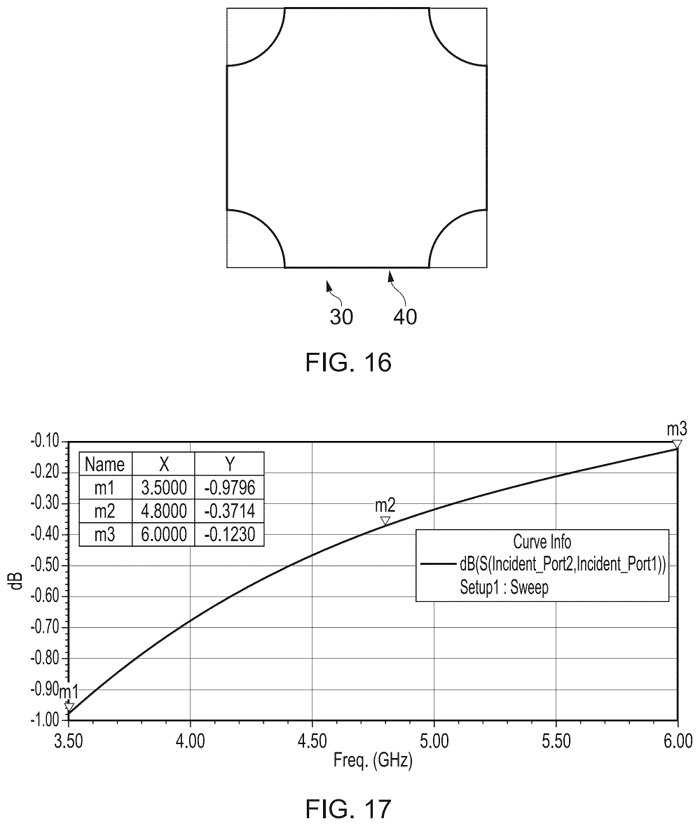

FIG. 16 shows a chamfered square loop unit cell 30 with an outer chamfered conductive loop 40 that is used in a 3×3 FSS array, the 3×3 array forming a dipole arm. This is similar to the chamfered square loops of FIG. 5 but is used in a 3×3 array rather than in a 2×2 array. The transmission response shown in FIG. 17 shows reduced transmission at the lower frequencies particularly below 5.5 GHz when compared to the 2×2 array of FIG. 5.

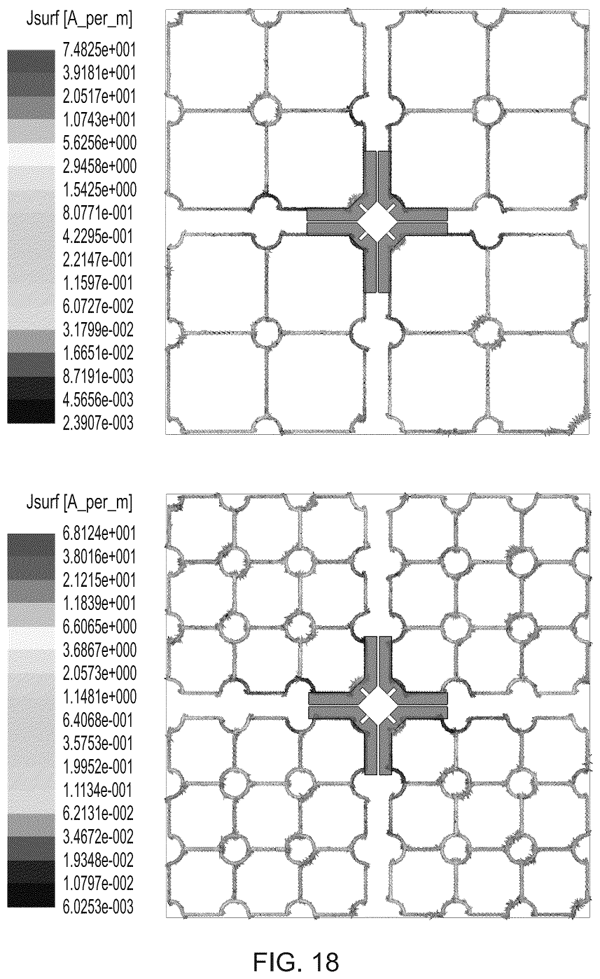

FIG. 18 shows the surface current running through the conductive loops of a dipole arm of a lower frequency antenna with integrated FSS and very thin radiator conductor at 870 MHz for a 2×2 array dipole arm and a 3×3 array dipole arm. The figures show the maximum current in the 2×2 array with chamfered edges is 75 A/m while that in the 3×3 array is 68 A/m. Thus, as can be seen the current strength in the dipole arm with a larger array is slightly lower than the current strength in a dipole arm with a smaller array. Note the different scales in the two figures.

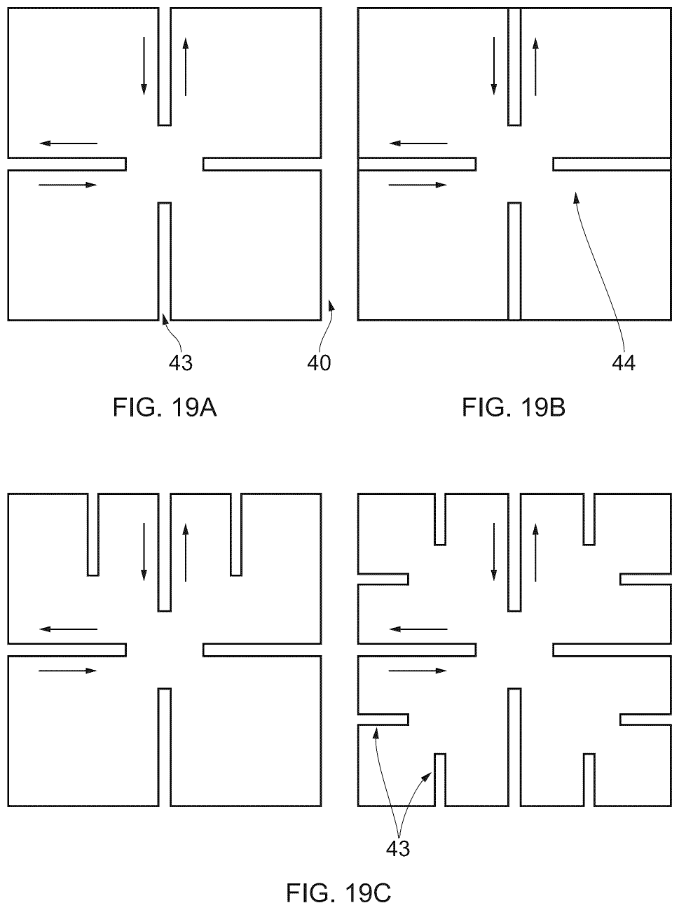

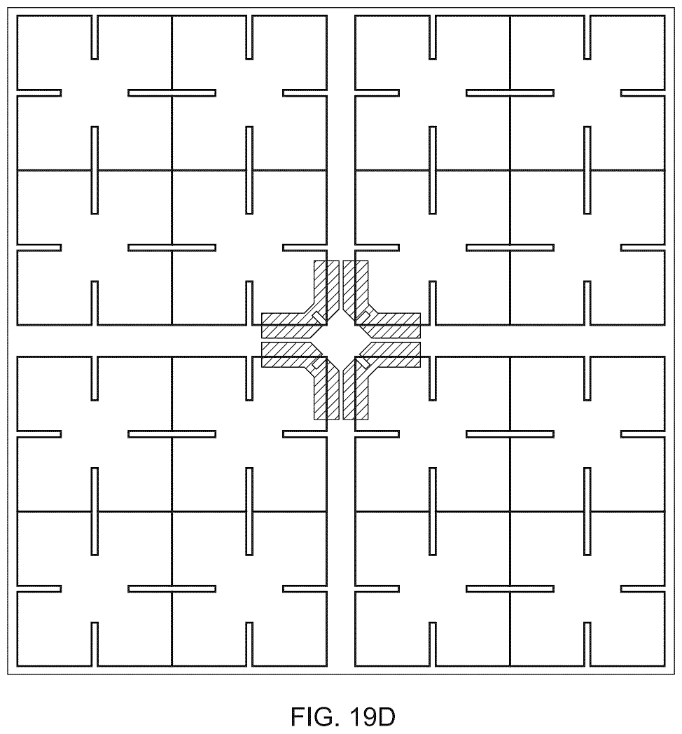

FIG. 19A shows an embodiment where the conductive loops 40 have indents 43 or U-shapes that form two parallel conductors or transmission lines in which the current flows in opposite directions. These features can pick up resonance from a higher frequency and weaken the field due to the opposite directions of the induced currents and render the antenna substantially transparent to this higher frequency. This acts in a similar way to the currents in the outer perimeter of the loops without indents 43 shown in FIG. 11. Resonance may occur particularly effectively where the length of the indents is ¼ wavelength of the higher frequency signal.

FIG. 19B shows an alternative embodiment where the parallel conductors 44 are not indents formed by diversion of the conductor loop but are parallel conductive tracks extending from the loops at adjacent positions. These function in a similar way to those of FIG. 19A.

FIG. 19C shows an alternative embodiment where multiple indents 43 of different lengths may be used to extend the bandwidth to which the loop is transparent or make the loop transparent to one or more additional frequency bands.

FIG. 19D shows a low frequency band antenna that is transparent to a higher frequency band according to an embodiment. This is formed with arms having a 2×2 array of conductive loops with indents as shown in FIG. 19A.

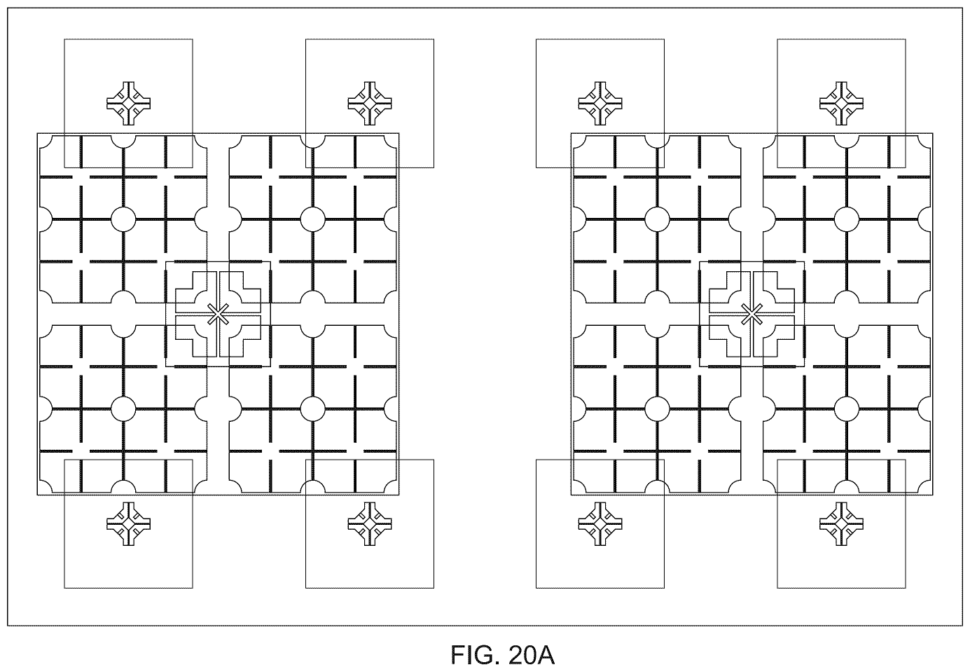

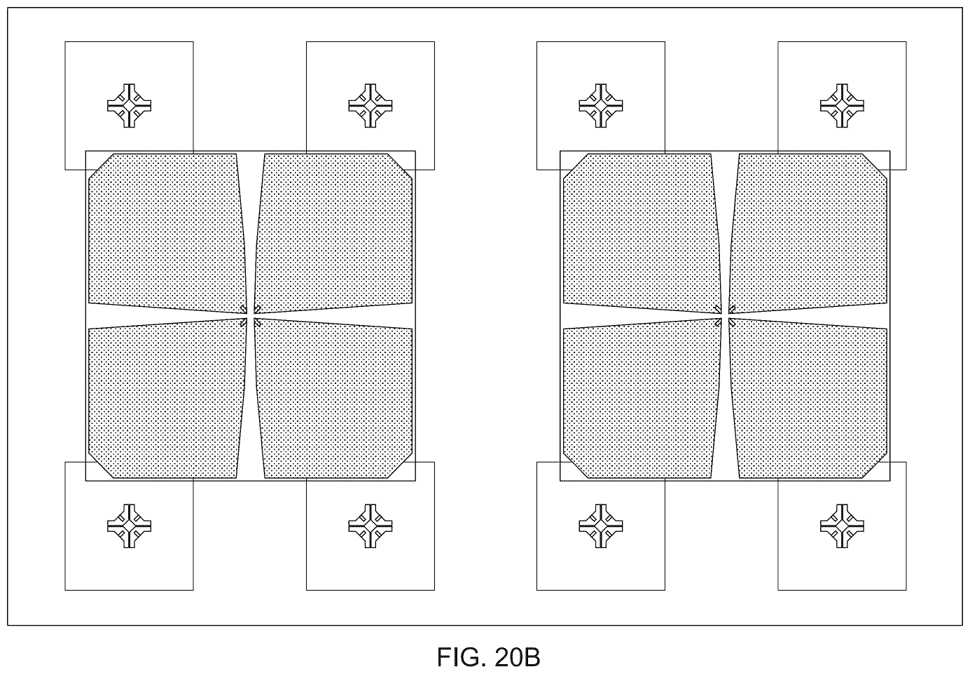

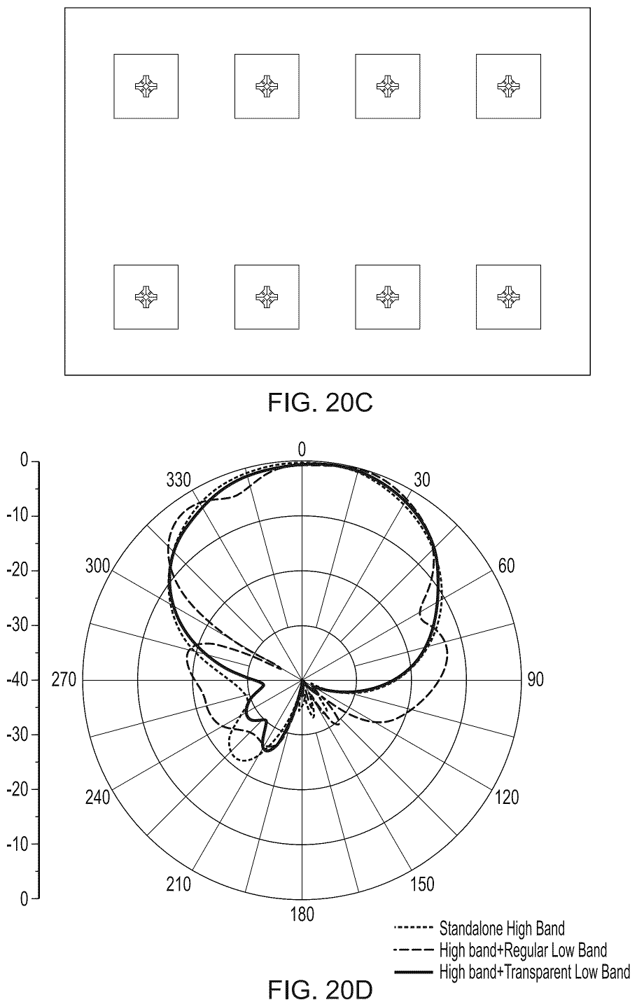

FIG. 20A shows a multi-band antenna according to an embodiment where the low band antenna is located above the higher band antenna and comprises conductive loops with indents as shown in FIG. 19.

FIG. 20B shows a conventional multi-band antenna where the lower band antenna does not comprise conductive loops.

FIG. 20C shows a high band antenna without a low band antenna adjacent to it.

FIG. 20D shows the high frequency radiation pattern of the antennas of FIGS. 20A to 20C. As can be seen the conventional lower band antenna of FIG. 20B distorts the high frequency field, while the more transparent low band antenna according to the embodiment illustrated in FIG. 20A provides very little distortion of the high frequency field.

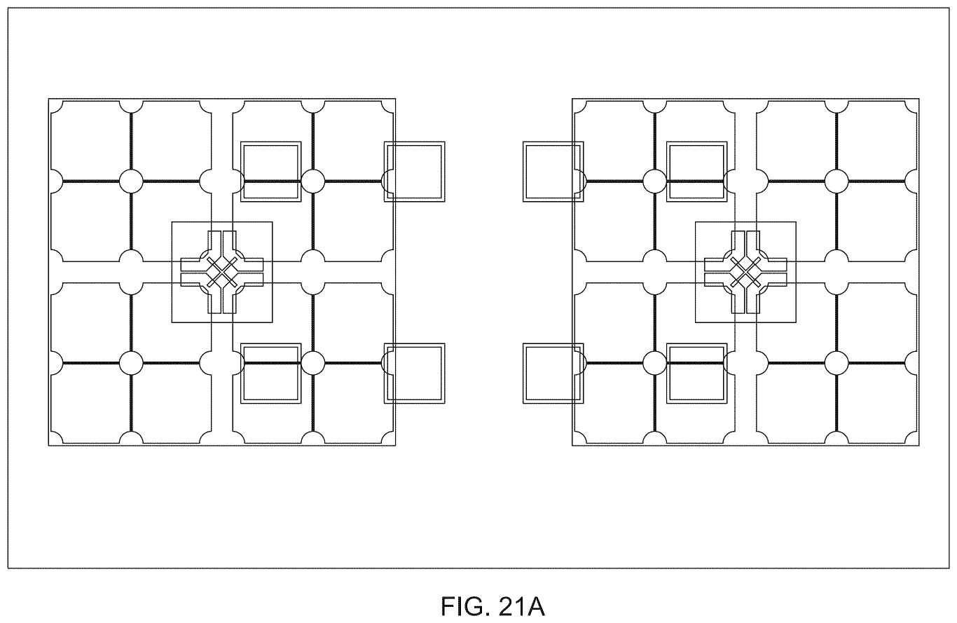

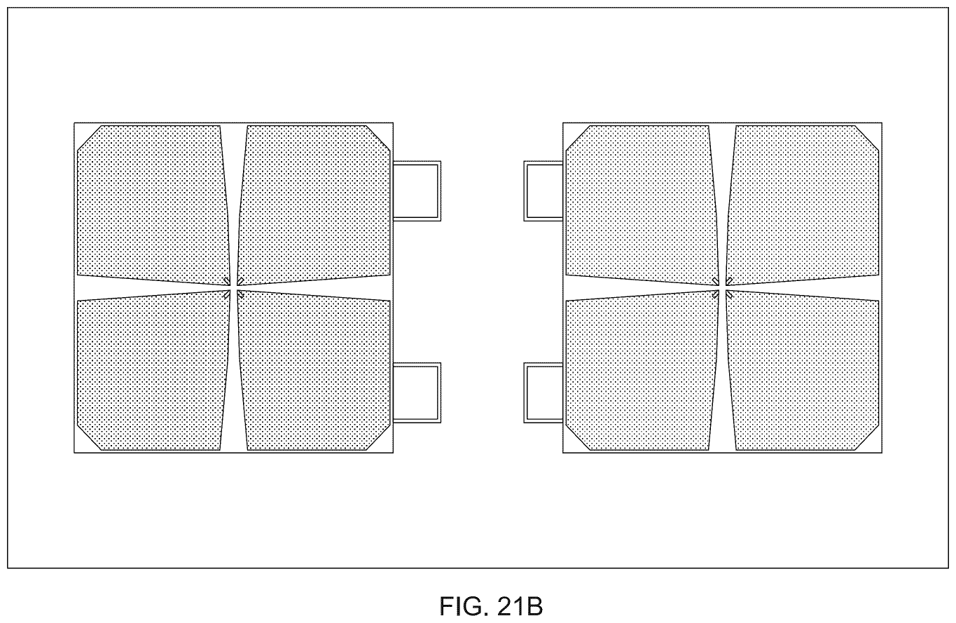

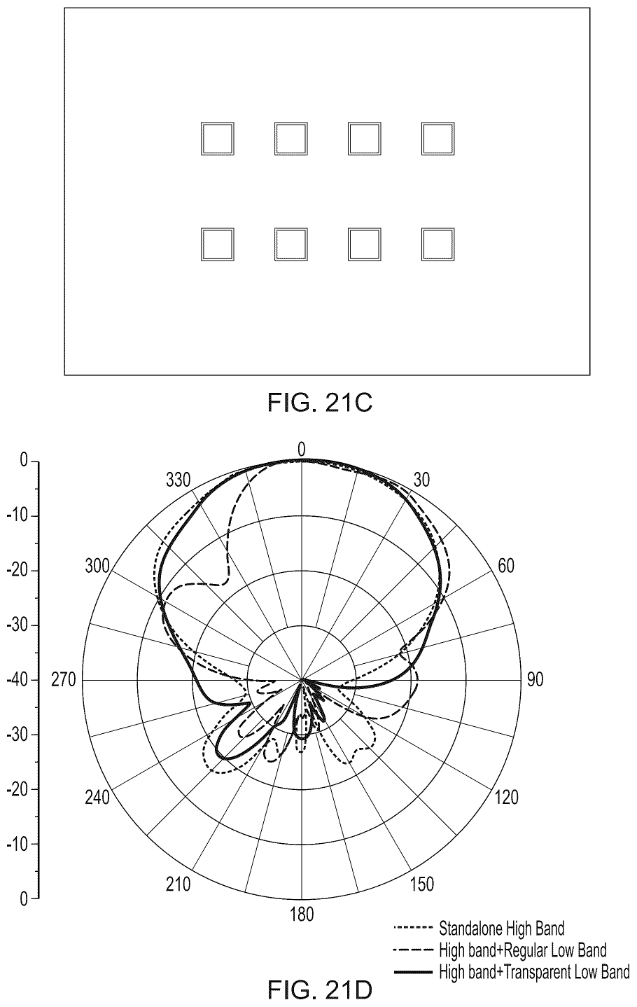

FIGS. 21A-D correspond to Figures of 20A-D but in this case the antenna according to an embodiment shown in FIG. 21A comprises conductive loops without indents. Again there is less distortion of the high frequency field with the low band antenna according to an embodiment, although it is not as effectively transparent to the higher band as the embodiment of FIG. 20A with the indents.

It should be noted that the length of the U-shaped tracks or “indents” on the conductive loops of FIG. 20A adjust the higher frequency band that the lower frequency antenna is transparent to and/or can provide an additional higher frequency band that the antenna is transparent to.

FIGS. 20 and 21 relate to different higher frequency antennas—see FIGS. 20C and 21C respectively which higher frequency antennas operate in different higher frequency bands. The lower frequency antenna in FIG. 21A is configured to be substantially transparent to the higher frequency band of operation of the antenna of FIG. 21C while the lower frequency antenna in FIG. 20A is configured to operate with the higher frequency antenna shown in FIG. 20C.

Although illustrative embodiments of the disclosure have been disclosed in detail herein, with reference to the accompanying drawings, it is understood that the disclosure is not limited to the precise embodiment and that various changes and modifications can be effected therein by one skilled in the art without departing from the scope of the disclosure as defined by the appended claims and their equivalents.

1. A lower frequency band antenna for a multiband antenna system, said multiband antenna system comprising at least one lower frequency band antenna and at least one higher frequency band antenna, said lower frequency band antenna comprising:
a substrate mounting a plurality of dipole arms each comprising a plurality of conductive loops, said substrate and dipole arms forming a frequency selective surface predominantly transparent to said higher frequency band and resonating at said lower frequency band; wherein
each of said dipole arms comprises an array of cells, each cell comprising at least one of said plurality of conductive loops configured as an outer conductive cell loop defining an outer periphery of said cell, a size of said outer conductive cell loop determining said higher frequency band that said frequency selective surface is transparent to, and a size and number of cells in said array determining said lower frequency band that said antenna resonates at; wherein
at least one of said dipole arms comprises an array of conductive loops with no conductive patches within said outer conductive cell loop.

2. A lower frequency band antenna according to claim 1, wherein all of said dipole arms comprise an array of conductive loops with no conductive patches within said outer conductive cell loops.

3. A lower frequency band antenna according to claim 1, wherein at least one other of said dipole arms comprise cells that each comprise at least one conductive patch within and surrounded by said outer conductive cell loop.

4. A lower frequency band antenna according to claim 1, wherein said at least one of said dipole arm comprises active elements that consists of said array of said conductive loops.

5. A lower frequency band antenna according to claim 3, wherein a subset of said dipole arms comprise cells that each comprise at least one conductive patch within and surrounded by said outer conductive cell loop, and the other of said dipole arms comprise cells that comprise no conductive patches within said outer conductive cell loop.

6. A lower frequency band antenna according to claim 1, wherein said outer conductive cell loops comprises a conductive track forming four sides of said loop, at least one of said sides comprises a conductive track that extends from said conductive loop towards but not as far as a centre of said loop and returns along an adjacent parallel path to form a U-shaped conductive track.

7. A lower frequency band antenna according to claim 6, wherein said U-shaped conductive track is formed by an indent in said conductive track forming said loop.

8. A lower frequency band antenna according to claim 6, wherein said U-shaped conductive track is attached to said conductive track forming said loop at two points on said side of said conductive loop.

9. A lower frequency band antenna according to claim 6, wherein at least two of said conductive sides of said loop each comprise at least one U-shaped conductive track extending from said side.

10. A lower frequency band antenna according to claim 9, wherein said U-shaped conductive tracks are a same length.

11. A lower frequency band antenna according to claim 9, wherein at least one of said U-shaped conductive tracks extending from at least one side is a different length to at least one of said U-shaped conductive tracks extending from at least one other side.

12. A lower frequency band antenna according to claim 9, wherein at least one side comprises multiple U-shaped conductive tracks.

13. A lower frequency band antenna according to claim 12, wherein at least two of said multiple U-shaped conductive tracks extending from a same side have different lengths.

14. A lower frequency band antenna according to claim 1, wherein the array of cells is surrounded by an outer conductive dipole loop which resonates within the desired lower frequency band and surrounds the plurality of cells within the dipole arm.

15. A lower frequency band antenna according to claim 14, wherein said outer conductive dipole loop surrounding said array of cells comprises four straight conductive tracks of a substantially same length, the lower frequency band that the dipole arm resonates at being related to a size of said outer conductive dipole loop.

16. A lower frequency band antenna according to claim 15, wherein said outer conductive cell loops each have chamfered corners, said chamfered corners comprise concave curved sections joining adjacent straight conductive tracks.

17. (canceled)

18. A lower frequency band antenna according to claim 14, wherein said outer conductive cell loops of neighbouring cells share conductive tracks, such that a conductive track running along a side of one loop is the same conductive track on an adjoining side of a neighbouring cell.

19. A lower frequency band antenna according to claim 1, wherein at least one of said dipole arms consists of an array of a first predetermined number of conductive loops and at least one other of said dipole arms consists of an array of a second predetermined number of conductive loops, said first and second predetermined numbers being different numbers.

20. A lower frequency band antenna according to claim 1, wherein said conductive loops are formed of conductive tracks having a width of between 0.1 mm and 1.0 mm, preferably between 0.2 mm and 0.5 mm.

21. An antenna system comprising at least one lower frequency band antenna according to claim 1, and at least one higher frequency band antenna, wherein said antenna system further comprises a signal feed, said signal feed being mounted on an other side of said substrate to said conductive loops.

22. (canceled)

23. (canceled)
